(19) United States
(12) Patent Application Publication
(10) Pub. No.: US 2023/0012914 A1
(43) Pub. Date: Jan. 19, 2023

(54) NON-TRANSITORY COMPUTER READABLE STORAGE, OUTPUT CONTROL METHOD, AND TERMINAL DEVICE

(71) Applicant: JAPAN COMPUTER VISION CORP., Tokyo (JP)

(72) Inventors: Toshihiro UTSUMI, Tokyo (JP); Nozomu HAYASHIDA, Tokyo (JP); Yusuke HIURA, Tokyo (JP)

(73) Assignee: JAPAN COMPUTER VISION CORP., Tokyo (JP)

(21) Appl. No.: 17/528,596

(22) Filed: Nov. 17, 2021

(30) Foreign Application Priority Data
Jul. 14, 2021 (JP) 2021-116080

(51) Int. Cl. G06F 21/84; G06K 9/00; G06T 7/70; G06T 7/50; G06F 3/14; G08B 5/22; G06F 21/32

(52) U.S. Cl. CPC G06F 21/84; G06K 9/00228; G06T 7/70; G06T 7/50; G06K 9/00771; G06K 9/00288; G06F 3/14; G08B 5/22; G06F 21/32; G06T 2207/30201

(57) ABSTRACT

An output control program according to the present application is executed by a terminal device. Specifically, the output control program according to the present application causes the terminal device to execute detecting a specific object from a captured image captured by an imaging unit of the terminal device, determining whether the specific object detected satisfies a predetermined condition when the specific object is detected in the detecting, and controlling an output by executing a predetermined output control corresponding to the specific object when the specific object detected is determined as satisfying the predetermined condition in the determining.

### CROSS-REFERENCE TO RELATED APPLICATION(S)

The present application claims priority to and incorporates by reference the entire contents of Japanese Patent Application No. 2021-116080 filed in Japan on Jul. 14, 2021.

### BACKGROUND OF THE INVENTION

### 1. Field of the Invention

The present invention relates to a non-transitory computer readable storage medium, an output control method, and a terminal device.

### 2. Description of the Related Art

Conventionally, in order to prevent leakage, falsification, and the like of information, there has been proposed a technique of permitting operation only to a user whose authenticity is guaranteed.
Patent Literature 1: JP 2017-91276 A

For example, in the above-described conventional technique, a process is performed in which an authentication pulse wave that is a pulse wave of a user when a biological recognition process is successful is collated with a face pulse wave detected from a face image of the user. Then, depending on whether or not both the pulse waves coincide with each other, predetermined operation control is performed on the operation of the user on the device (for example, PC).

However, it cannot be said that it is possible to effectively prevent a so-called shoulder surfing, which is to obtain input information by looking from behind or next to an operator inputting information to the device, by simply performing an operation control as in the above-described conventional technique, in some cases.

For this reason, it is required to provide a user interface for preventing an act related to a shoulder surfing to illegally acquire information of another person.

### SUMMARY OF THE INVENTION

It is an object of the present invention to at least partially solve the problems in the conventional technology.

According to one aspect of an embodiment, an output control program executed by a terminal device, the output control program causing the terminal device to execute detecting a specific object from a captured image captured by an imaging unit of the terminal device. The output control program causing the terminal device to execute determining whether the specific object detected satisfies a predetermined condition when the specific object is detected in the detecting. The output control program causing the terminal device to execute controlling an output by executing a predetermined output control corresponding to the specific object when the specific object detected is determined as satisfying the predetermined condition in the determining.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram illustrating a specific example of an output control process according to an embodiment;

FIG. 2 is a diagram illustrating a configuration example of a terminal device according to the embodiment;

FIG. 3 is a diagram illustrating an example of a registration information database according to the embodiment;

FIG. 4 is a flowchart (1) illustrating an example of an output control procedure according to the embodiment;

FIG. 5 is a flowchart (2) illustrating an example of the output control procedure according to the embodiment;

FIG. 6 is a flowchart (3-1) illustrating an example of the output control procedure according to the embodiment;

FIG. 7 is a flowchart (3-2) illustrating an example of the output control procedure according to the embodiment; and

FIG. 8 is a hardware configuration diagram illustrating an example of a computer that implements a function of the terminal device.

### DETAILED DESCRIPTION OF THE PREFERRED EMBODIMENTS

Hereinafter, a mode (hereinafter referred to as “embodiment”) for implementing an output control program, an output control method, and a terminal device according to the present application will be described in detail with reference to the drawings. Note that the output control program, the output control method, and the terminal device according to the present application are not limited by the embodiment. In the following embodiments, the same units are denoted by the same reference numerals to omit redundant description.

1. Outline of Output Control Process

First, an outline of an output control process according to the embodiment will be described. The output control process according to the embodiment is realized by a terminal device 10 having an imaging function.

Specifically, the terminal device 10 executes the output control process in accordance with the control of the output control program according to the embodiment. According to the output control program, the terminal device 10 determines that there is a risk of shoulder surfing in a case where a plurality of persons appears or an unregistered person appears in an imaging area, or in a case where an act of or an object for illegally acquiring information appears in the imaging area of an imaging unit (for example, a camera) included in the terminal device 10. Then, the terminal device 10 performs output control so as to output information that can prevent the shoulder surfing from happening.

Note that the output control program according to the embodiment may conform to a predetermined operating system (OS), or may be provided as a dedicated application independent of the OS. In addition, the output control program according to the embodiment may be implemented as one function of a general-purpose application (for example, the browser).

Furthermore, the terminal device 10 can be realized by, for example, a smartphone, a tablet terminal, a notebook personal computer (PC), a desktop PC, a mobile phone, a personal digital assistant (PDA), or the like. Furthermore, the imaging unit included in the terminal device 10 may be a camera incorporated in advance or an external camera (for example, a web camera) independent of the terminal device 10.

Furthermore, the following embodiment will describe an example in which the terminal device 10 performs the output control process according to the embodiment in a stand-alone manner in accordance with the control of the output control program. However, for example, the terminal device 10 may perform the output control process in cooperation with an external information processor. In such a case, at least a part of the process described as being performed by the terminal device 10 in the following embodiment may be performed on the external information processor.

Furthermore, in a case where the terminal device 10 is an edge computer that performs edge processing near a user, the external information processor may be, for example, a server device existing on the cloud side.

2. Specific Example of Output Control Process

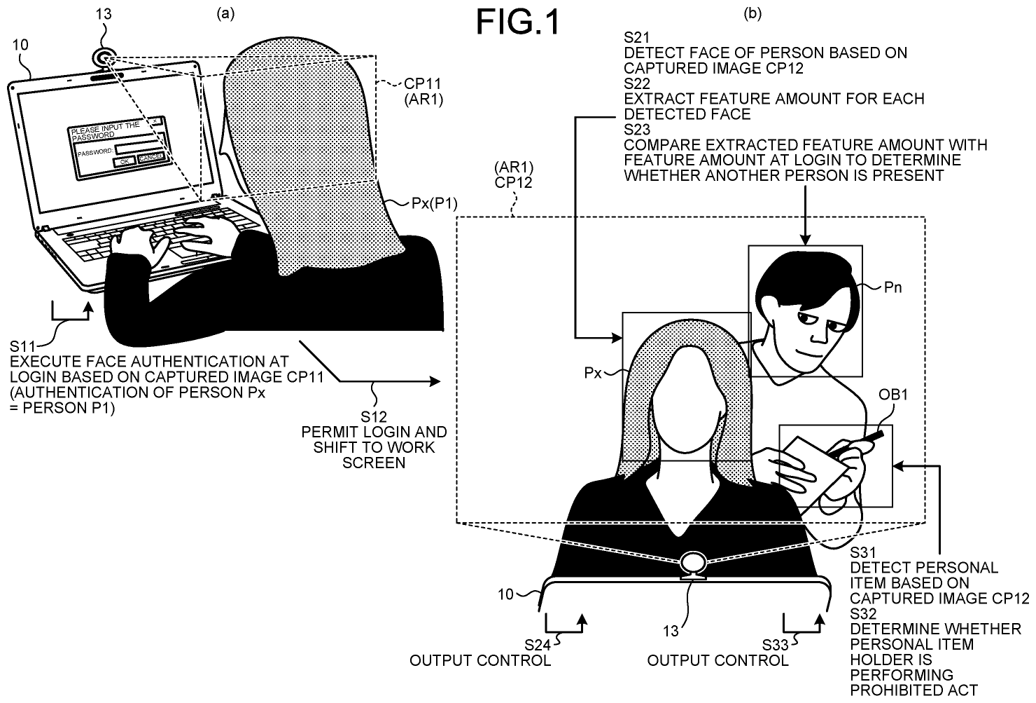

Next, a specific example of the output control process according to the embodiment will be described with reference to FIG. 1. FIG. 1 is a diagram illustrating a specific example of the output control process according to the embodiment. FIG. 1 illustrates a scene where the output control process according to the embodiment is performed while a user Px (person Px) of the terminal device 10 attempts to login to a predetermined work screen (for example, a dedicated application screen handled in a user's organization) to after the login.

Furthermore, as illustrated in FIG. 1, the terminal device 10 includes an imaging unit 13 that is an example of the imaging unit. As described above, the imaging unit 13 may be a built-in camera or an external camera. For example, when a specific object is detected in an imaging area AR1, the imaging unit 13 may capture a captured image in which the object detected is present. Specifically, when detecting a face (or object) of a person in the imaging area AR1, the imaging unit 13 may capture a captured image in which a portion of the detected face (or object) is present in the captured image.

Here, according to the example in FIG. 1(a), the user Px of the terminal device 10 operates the terminal device 10 to start a login screen (password input screen) in order to attempt login to the predetermined work screen. In such a case, the imaging unit 13 detects entry of the person Px into the imaging area AR1 and captures a captured image including the face of the person Px. FIG. 1(a) illustrates the example in which the imaging unit 13 captures a captured image CP11.

In such a state, when acquiring the captured image CP11 from the imaging unit 13, the terminal device 10 executes face authentication on the basis of the captured image CP11 acquired (Step S11). In other words, the terminal device 10 executes face authentication at the time of login. For example, the terminal device 10 performs personal authentication using a face authentication technology on the basis of the captured image CP11 and a registered image registered in advance.

Specifically, the terminal device 10 extracts a feature amount (feature amount of a process target) indicating a facial feature from the captured image CP11. In addition, the terminal device 10 extracts the feature amount indicating the facial feature (feature amount of a comparison target) also from each of registered images. Then, the terminal device 10 calculates a similarity of the face for each registered image by collating the feature amount of the comparison target with the feature amount of the process target. Then, in a case where there is a registered image whose similarity exceeds a predetermined threshold, the terminal device 10 authenticates the user Px as a person in the registered image (i.e., a valid user whose face image is registered). FIG. 1(a) illustrates an example in which the terminal device 10 authenticates the user Px as a person P1 himself/herself.

In addition, the terminal device 10 permits login and shifts a screen to the work screen in the login destination in response to the fact that the user Px can be authenticated as the valid person as in the above example (Step S12).

Next, FIG. 1(b) will be described. According to an example in FIG. 1(b), the user Px is working via the work screen. In such a case, the imaging unit 13 detects entry of the user Px in the imaging area AR1 and captures a captured image including the face of the user Px. FIG. 1(b) illustrates an example in which the imaging unit 13 captures a captured image CP12. Note that, according to the example in FIG. 1(b), the captured image CP12 includes not only the user Px but also a face of another person Pn who is different from the user Px.

In such a state, when acquiring the captured image CP12 from the imaging unit 13, the terminal device 10 detects the face of the person on the basis of the captured image CP12 acquired (Step S21). As illustrated in FIG. 1(b), since the captured image CP12 includes the face of the user Px and the face of the other person Pn, the terminal device 10 detects, for example, a face area corresponding to the face of the user Px and a face area corresponding to the face of the other person Pn by image analysis of the captured image CP12. In other words, the terminal device 10 detects two face areas.

In addition, the terminal device 10 extracts the feature amount indicating the facial feature included in the face area of each detected face area (Step S22).

Next, the terminal device 10 compares the feature amounts extracted in Step S22 with the feature amount extracted from the captured image CP11 captured at the time of login, and determines whether or not another person different from the user Px authenticated as the person P1 is present in the captured image CP12 (Step S23). According to the example in FIG. 1(b), the terminal device 10 determines that another person different from the authenticated user Px is present in the captured image CP12.

When it is determined that another person is present in this manner, the terminal device 10 recognizes a risk of shoulder surfing by this other person. Therefore, the terminal device 10 executes a predetermined output control corresponding to the presence of the other person (Step S24). For example, the terminal device 10 executes the output control to prevent an act of another person trying to illegally acquire information on the work screen from behind (example of a shoulder surfing).

For example, the terminal device 10 can control a display mode of the work screen by a predetermined display control process on a display screen. As an example, the terminal device 10 can reduce a visibility of the work screen by adjusting a brightness of the display screen, or can reduce the visibility of the work screen by performing mosaic control on the display screen. In addition to such example, the terminal device 10 can also switch off the power of the display screen itself or reduce the size of the work screen.

Furthermore, the terminal device 10 may output alert information in response to the fact that another person is present. For example, the terminal device 10 can display the alert information (for example, text information to warn such as “It will be visible from the person behind”) warn that there is a risk of peeping from the surroundings with respect to the work screen on the display screen. In addition, the terminal device 10 can generate audio output of the alert information (for example, alert information directed to another person such as “A person behind! Are you trying to view the screen?”) to warn against unauthorized acquisition of information on the work screen.

Steps S21 to S23 have described an example in which the terminal device 10 detects the face of the person as the specific object to perform the output control process corresponding to the detection result. However, the terminal device 10 may detect a personal item of the person as the specific object to perform the output control process corresponding to the detection result.

Hereinafter, this point will be described also using the example in FIG. 1.

For example, when acquiring the captured image CP12 from the imaging unit 13, the terminal device 10 detects a specific personal item owned by the person on the basis of the captured image CP12 acquired (Step S31). As a specific example, the terminal device 10 detects a predetermined recording unit (an example of specific personal item) capable of recording information of the work screen. Examples of such recording unit include writing tools and information devices having an imaging function (for example, a smartphone).

As illustrated in FIG. 1(b), the captured image CP12 illustrates a state in which the other person Pn possesses a writing tool OB1. Therefore, the terminal device 10 detects, for example, an object area corresponding to the writing tool OB1 by image analysis on the captured image CP12.

In response to the detection of the writing tool OB1, the terminal device 10 determines whether or not an owner of the writing tool OB1 (in the example in FIG. 1(b), the other person Pn) is performing a predetermined prohibited act (Step S32). Specifically, the terminal device 10 determines whether or not the owner of the writing tool OB1 is performing the prohibited act of illegally acquiring information on the work screen. According to the example in FIG. 1(b), the terminal device 10 determines that the owner of the writing tool OB1 is performing the prohibited act in response to the detection of the writing tool OB1.

When it is determined that the prohibited act is performed in this manner, the terminal device 10 recognizes the risk of the shoulder surfing by the owner. Therefore, the terminal device 10 executes a predetermined output control corresponding to the prohibited act related to the writing tool OB1 (Step S33). For example, the terminal device 10 can generate audio output of the alert information (for example, alert information directed to the owner such as “A person behind! Are you trying to transcribe the screen?”) to warn against unauthorized acquisition of information on the work screen.

As described above with reference to FIG. 1, the terminal device 10 detects the specific object (for example, the face of the person and the recording unit that can be used to illegally acquire information) from the captured image captured by the imaging unit 13 in accordance with the output control program. Then, when the specific object is detected, the terminal device 10 determines whether or not there is a risk of the shoulder surfing related to the object. When it can be determined that there is a risk, the terminal device 10 performs the output control so as to output predetermined information that can prevent the shoulder surfing.

Accordingly, the output control program can achieve an advantageous effect of providing a user interface that prevents the act of illegally acquiring information of another person, as compared with the conventional technique in which predetermined operation control is performed on a user's operation on a device (for example, PC).

3. Configuration of Terminal Device

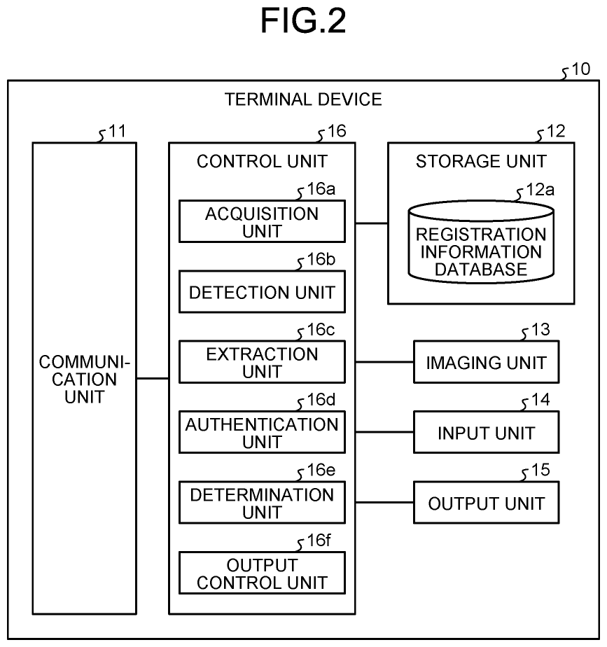

Hereinafter, the terminal device 10 according to the embodiment will be described with reference to FIG. 2. FIG. 2 is a diagram illustrating a configuration example of the terminal device 10 according to the embodiment. As illustrated in FIG. 2, the terminal device 10 includes a communication unit 11, a storage unit 12, the imaging unit 13, an input unit 14, an output unit 15, and a control unit 16.

Communication Unit 11

The communication unit 11 is realized by, for example, a network interface card (NIC) or the like. The communication unit 11 is connected to a network in a wired or wireless manner, and transmits and receives information to and from, for example, an external information processor.

Storage Unit 12

The storage unit 12 is realized by, for example, a semiconductor memory element such as a random access memory (RAM) and a flash memory, or a storage device such as a hard disk and an optical disk. The storage unit 12 includes a registration information database 12a.

Registration Information Database 12a

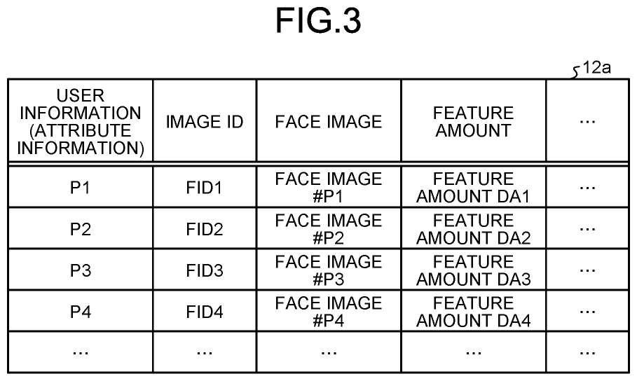

The registration information database 12a stores information on the face image received from the user as pre-registration. Here, FIG. 3 illustrates an example of the registration information database 12a according to the embodiment.

In the example in FIG. 3, the registration information database 12a includes items such as “user information”, “image identifier (ID)”, “face image”, and “feature amount”.

The “user information” is various types of information regarding the user, and may include, for example, attribute information such as an address, a name, an age, and a gender of the user. The “image identifier (ID)” indicates identification information for identifying the registered face image (registered image). The “face image” is data of a face image identified by the “image ID”. The “feature amount” is information indicating a feature amount extracted from the “face image”.

FIG. 3 illustrates an example in which an image ID “FID1”, a face image “#P1”, and a feature amount “DA1” are associated with the user information “P1”. This example indicates that the person P1 registers his/her own face image “#P1” to the terminal device 10, so that the image ID “FID1” for identifying this face image is issued and given to the face image “#P1”.

Note that, when the terminal device 10 cooperates with the external information processor (for example, a server device), the face image may be registered to the server device. Furthermore, in such a case, the server device may issue the image ID or extract the feature amount, and these pieces of information may be stored in the storage unit of the server device. In addition, the terminal device 10 may acquire the information from the storage unit of the server device, and store the acquired information in the registration information database 12a.

Furthermore, the terminal device 10 does not necessarily need to include the registration information database 12a, and a configuration to refer to a storage unit included in the external information processor may be adopted.

Imaging Unit 13

Returning to FIG. 2, the imaging unit 13 corresponds to a camera function of capturing an image of a target. Although the example in FIG. 2 illustrates an example of the imaging unit 13 built in the terminal device 10, the imaging unit 13 may be externally attached to the terminal device 10.

Input Unit 14 and Output Unit 15

The input unit 14 is an input device that receives various operations by the user. For example, the input unit 14 is realized by a keyboard, a mouse, an operation key, or the like. The output unit 15 is a display device that displays various types of information. For example, the output unit 15 may be a display screen realized by a liquid crystal display or the like. Note that, in a case where a touch panel is adopted for the terminal device 10, the input unit 14 and the output unit 15 may be integrated.

Furthermore, the output unit 15 may be a speaker that outputs sound. Furthermore, the output unit 15 performs brightness control, power supply control, or information output control corresponding to the control by an output control unit 16f.

Control Unit 16

The control unit 16 is realized by a central processing unit (CPU), a micro processing unit (MPU), or the like, using the RAM as a work area to execute various programs (for example, the output control program according to the embodiment) stored in the storage device inside the terminal device 10. The control unit 16 is also realized by an integrated circuit such as an application specific integrated circuit (ASIC) or a field programmable gate array (FPGA).

As illustrated in FIG. 2, the control unit 16 includes an acquisition unit 16a, a detection unit 16b, an extraction unit 16c, an authentication unit 16d, a determination unit 16e, and the output control unit 16f, and implements or executes functions and actions of information processing described below. Note that the internal configuration of the control unit 16 is not limited to the configuration illustrated in FIG. 2, and may be another configuration as long as information processing described later is performed. Furthermore, the connection relationship of processing units included in the control unit 16 is not limited to the connection relationship illustrated in FIG. 2, and may be another connection relationship.

Acquisition Unit 16a

The acquisition unit 16a acquires various types of information used in the output control process according to the embodiment. For example, the acquisition unit 16a acquires information regarding pre-registration from the user. For example, the acquisition unit 16a acquires the face image to be registered from the user, thereby registering the acquired face image in the registration information database 12a.

Furthermore, when the imaging unit 13 captures the face image, the acquisition unit 16a acquires the captured face image as the captured image.

Detection Unit 16b

The detection unit 16b detects the specific object from the captured image captured by the imaging unit 13. For example, the detection unit 16b detects a person as the specific object. For example, the detection unit 16b may detect a part of the body (for example, a part of the face) of the person.

In addition, with respect to the face image of the user of the terminal device 10, the authentication unit 16d described later authenticates the user as the valid person whose face image is registered, as a result of performing personal authentication of the user on the basis of the face image captured at the time of login and the face image registered in advance. In such a case, among the captured images captured by the imaging unit 13, the detection unit 16b detects the person from the captured image captured when the screen in the login destination is displayed.

Here, a face of a person in a poster, a photograph, or the like may be included in the captured image. Therefore, the detection unit 16b may identify whether or not the captured image is a valid face image obtained by capturing an image of a living person. For example, the detection unit 16b may identify whether or not the face in the captured image is a real-time face by image analysis or biometric authentication (biometric identification) on the captured image.

Extraction Unit 16c

The extraction unit 16c extracts the feature amount from the face image. For example, the extraction unit 16c extracts the feature amount from the registered image that is the registered face image. Furthermore, the extraction unit 16c extracts the feature amount from the captured image (for example, the captured image captured by the imaging unit 13). For example, the extraction unit 16c acquires the feature point indicating a face pattern from the face image, and quantifies the feature point acquired to extract the feature amount corresponding to the feature point. Furthermore, the extraction unit 16c can store the feature amount extracted from the registered image in the registration information database 12a.

Authentication Unit 16d

The authentication unit 16d performs personal authentication for determining whether or not a person in the captured image is the valid person whose face image is registered, on the basis of the captured image captured by the imaging unit 13 and the registered image registered in advance. For example, the authentication unit 16d calculates the similarity between the face in the face image and the face in the registered image by collating the feature amount of the process target extracted from the captured image with the feature amount of the comparison target extracted from the registered image. Then, the authentication unit 16d authenticates an identity of the person in the captured image on the basis of a relationship between a calculated similarity and the threshold serving as a criterion for determining the personal authentication.

For example, the authentication unit 16d performs the personal authentication of the user on the basis of the face image of the user of the terminal device 10 captured by the imaging unit 13 at the time of login and the face image registered in advance. Note that the authentication unit 16d rejects the login of the user when the user cannot be authenticated as the valid person whose face image is registered.

Determination Unit 16e

When the detection unit 16b detects the specific object, the determination unit 16e determines whether or not the specific object detected satisfies a predetermined condition.

For example, when the detection unit 16b detects a person, the determination unit 16e determines whether or not a plurality of persons is present in front of the display screen of the terminal device 10 on the basis of the number of detected persons. In addition, the determination unit 16e may further determine whether or not display information displayed on the display screen of the terminal device is within the field of view of at least one of the plurality of persons on the basis of a face direction of each of the plurality of persons estimated from the captured image, a line-of-sight direction of each of the plurality of persons estimated from the captured image, or a distance to the terminal device of each of the plurality of persons estimated from the captured image.

When the detection unit 16b detects a specific personal item, the determination unit 16e determines whether or not the person possessing the personal item is performing the predetermined prohibited act using the specific personal item detected. The specific personal item may be a predetermined recording unit capable of recording the display information displayed on the display screen of the terminal device 10. When the detection unit 16b detects the predetermined recording unit, the determination unit 16e determines whether or not an act of recording the display information using the recording unit is performed as the predetermined prohibited act on the basis of a detected direction of the recording unit estimated from the captured image.

When the detection unit 16b detects the person, the determination unit 16e determines whether or not another person different from the user of the terminal device 10 is present in the person detected. In addition, the determination unit 16e may further determine whether or not the display information displayed on the display screen of the terminal device 10 is included in the field of view of the other person on the basis of the direction of the face of the other person estimated from the captured image, the line-of-sight direction of the other person estimated from the captured image, or the distance to the terminal device 10 of the other person estimated from the captured image.

Output Control Unit 16f

When the determination unit 16e determines that a predetermined condition is satisfied, the output control unit 16f executes the predetermined output control corresponding to the specific object.

For example, when the determination unit 16e determines that there is a plurality of persons in front of the display screen of the terminal device 10, the output control unit 16f executes a predetermined output control corresponding to the presence of the plurality of persons. Still more, when it is determined that the display information displayed on the display screen of the terminal device 10 is in the field of view of at least one of the plurality of persons, the output control unit 16f executes the predetermined output control corresponding to the presence of the plurality of persons.

Furthermore, when the determination unit 16e determines that the person possessing the specific personal item is performing the predetermined prohibited act, the output control unit 16f executes the predetermined output control corresponding to the prohibited act.

Furthermore, when it is determined that another person different from the user of the terminal device 10 is present in the person detected from the captured image, the output control unit 16f executes a predetermined output control corresponding to the presence of another person.

For example, the output control unit 16f controls, as the predetermined output control, the display mode of the display information displayed on the display screen of the terminal device 10 by the display control according to the specific object. As an example, the output control unit 16f reduces the visibility of the display information displayed on the display screen by adjusting the brightness of the display screen. Alternatively, the output control unit 16f reduces the visibility of the display information displayed on the display screen by performing mosaic control on the display screen.

Furthermore, the output control unit 16f may control the display mode according to a secrecy level of the display information. Using the example in FIG. 1, the user Px sets, for example, the highest secrecy level “S” to the content provided by an attendance management application that benefits an organization to which the user Px belongs, and sets the secrecy level “A” to the content provided by an entertainment application.

Here, for example, the determination unit 16e determines that another person is present in the captured image CP12 captured when the content provided by the attendance management application is displayed. In such a case, the output control unit 16f may adjust the brightness of the display screen so as to minimize the visibility of the content.

On the other hand, for example, the determination unit 16e determines that another person is present in the captured image CP12 captured when the content provided by the entertainment application is displayed. In such a case, the output control unit 16f may adjust the brightness of the display screen so as to lower the visibility of the content to a medium level.

Furthermore, the output control unit 16f may cause predetermined alert information corresponding to the specific object to be output as the predetermined output control. For example, the output control unit 16f can output, as the predetermined alert information, the alert information to warn that there is a risk of peeping from the surroundings with respect to the display information displayed on the display screen of the terminal device 10. Furthermore, for example, the output control unit 16f can output, as the predetermined alert information, the alert information to warn not to perform the prohibited act related to unauthorized acquisition of the display information displayed on the display screen of the terminal device 10.

Note that, even in a case where it is determined that there is another person different from the user of the terminal device 10, the output control unit 16f may not execute the predetermined output control when the other person is registered in advance as a related person of the user. Here, the related person may be, for example, the user's family, a colleague of the user's workplace, a management supervisor of the user, or the like. Of course, the related person is not limited to the example, and may be any person as long as the person has some kind of close relationship with the user.

4. Processing Procedure

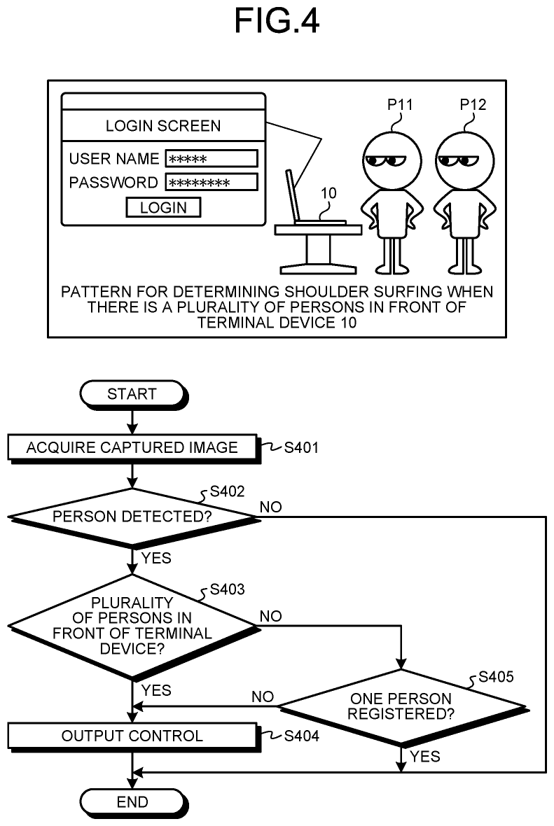

In FIG. 3, the output control process realized by the output control program according to the embodiment has been described from a conceptual aspect. Hereinafter, a more detailed example of the output control process realized by the output control program will be described with reference to FIGS. 4 to 7. Specifically, an example of the output control procedure according to the embodiment will be described for each pattern of the shoulder surfing.

4-1. Processing Procedure (1)

First, an example of the output control procedure according to the embodiment will be described with reference to FIG. 4. FIG. 4 is a flowchart (1) illustrating the example of the output control procedure according to the embodiment. FIG. 4 illustrates, as one pattern of the output control procedure, the example of a pattern in which the shoulder surfing is determined when there is a plurality of persons in front of the terminal device 10.

According to the example in FIG. 4, each time the presence of a person in the imaging area AR1 is detected, the imaging unit 13 of the terminal device 10 captures an image including a face of the person detected.

In such a state, the acquisition unit 16a acquires a captured image CPx captured by the imaging unit 13 (Step S401).

When the captured image CPx is acquired, the detection unit 16b detects the person by image analysis of the captured image CPx acquired (Step S402). For example, the detection unit 16b can detect the person on the basis of whether or not an image portion corresponding to a specific body part (for example, hair, a part of a face, or the like) appears so as to occupy a predetermined ratio with respect to the captured image CPx. Furthermore, for example, by dividing the captured image CPx into a predetermined number of areas, the detection unit 16b may detect the person on the basis of the ratio of which part of the image portion is present in which area.

In addition, the user may perform information setting so as to realize a detection process as described above.

Next, when the person is detected (Step S402; Yes), the determination unit 16e determines whether or not a plurality of persons is present in front of the display screen of the terminal device 10 on the basis of the number of detected persons (Step S403). In other words, the determination unit 16e determines whether or not the plurality of persons is present in the captured image CPx.

When it is determined that there is the plurality of persons in front of the display screen of the terminal device 10 (Step S403; Yes), the output control unit 16f recognizes that there is a risk of shoulder surfing by at least one of the plurality of persons. Then, the output control unit 16f executes the predetermined output control corresponding to the presence of the plurality of persons (Step S404). For example, when the login screen on which the password is being input is displayed on the display screen of the terminal device 10, the output control unit 16f reduces the visibility of the login screen by performing output control (for example, brightness adjustment, mosaic control, or the like) on the display screen.

According to the example in FIG. 4, the output control unit 16f reduces the visibility so that the information on the login screen is not viewed by persons P11 and P12 who are examples of the plurality of persons.

On the other hand, when it is determined that there is no plurality of persons in front of the display screen of the terminal device 10, that is, there is only one person in front of the display screen of the terminal device 10 (Step S403; No), the authentication unit 16d determines whether or not this one person is the valid person whose face image is registered through the face authentication (Step S405). For example, the authentication unit 16d collates the feature amount of the process target extracted from the captured image CPx with the feature amount of the comparison target extracted from the registered image registered in advance, thereby determining whether or not the person is the valid person whose face image is registered.

When this one person is determined as an unregistered person whose face image is not registered (Step S405; No), the output control unit 16f recognizes a risk of shoulder surfing by the unregistered person. Then, the output control unit 16f executes a predetermined output control corresponding to the presence of the unregistered person (Step S404).

On the other hand, when this one person is the valid person whose face image is registered (Step S405; Yes), the output control unit 16f recognizes that this one person is the owner of the terminal device 10, and there is no risk of shoulder surfing. When there is no risk of shoulder surfing as described above, the output control unit 16f may end the process without performing the output control.

Still more, returning to Step S402, when no person is detected (Step S402; No), the output control unit 16f ends the process without performing the output control.

Note that when it is determined that there is a plurality of persons in front of the display screen of the terminal device 10 (Step S403; Yes), the face direction (or the line-of-sight direction) of each of the plurality of persons may be estimated, for example, on the basis of the captured image CPx. Then, the determination unit 16e may determine whether or not the display information displayed on the display screen of the terminal device 10 is in the field of view of at least one of the plurality of persons on the basis of the face direction estimated. Still more, when it is determined that the display information is in the field of view of at least one of the plurality of persons, the output control unit 16f may execute the predetermined output control corresponding to the presence of the plurality of persons.

Furthermore, as another example, when it is determined that there is a plurality of persons in front of the display screen of the terminal device 10 (Step S403; Yes), a distance to the terminal device 10 of each of the plurality of persons may be estimated, for example, on the basis of the captured image CPx, and the determination unit 16e may determine whether or not the display information displayed on the display screen of the terminal device 10 is in the field of view of at least one of the plurality of persons on the basis of the estimated distance. Still more, when it is determined that the display information is in the field of view of at least one of the plurality of persons, the output control unit 16f may execute the predetermined output control corresponding to the presence of the plurality of persons.

4-2. Processing Procedure (2)

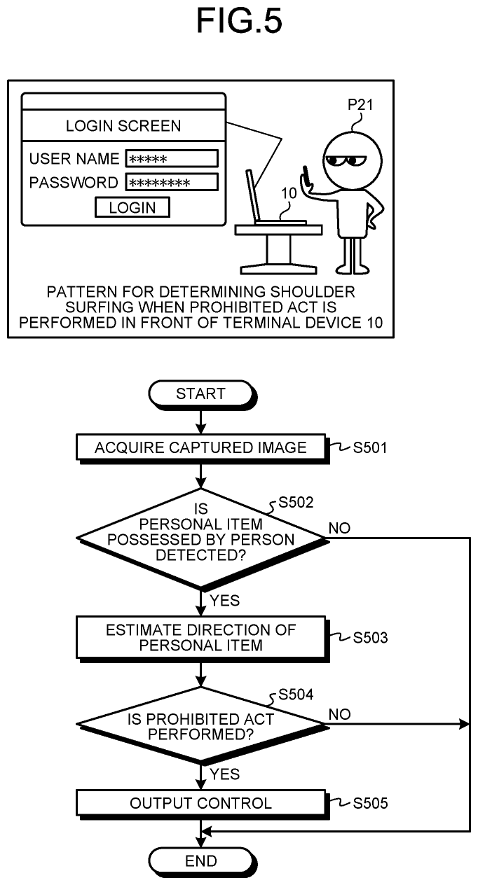

Next, an example of the output control procedure according to the embodiment will be described with reference to FIG. 5. FIG. 5 is a flowchart (2) illustrating the example of the output control procedure according to the embodiment. FIG. 5 illustrates, as one pattern of the output control procedure, an example of a pattern determined as shoulder surfing when the prohibited act is performed in front of the terminal device 10.

According to the example in FIG. 5, the imaging unit 13 of the terminal device 10 captures a captured image including a face of detected person each time the appearance of the person in the imaging area AR1 is detected.

In such a state, the acquisition unit 16a acquires the captured image CPx captured by the imaging unit 13 (Step S501).

When the captured image CPx is acquired, the detection unit 16b detects the specific personal item possessed by the person in the acquired captured image CPx (Step S502). For example, the detection unit 16b detects a recording unit capable of recording the display information displayed on the display screen of the terminal device 10. For example, the detection unit 16b can detect an information device (for example, a smartphone) having an imaging function, a writing tool, or the like.

When the specific personal item has been detected (Step S502; Yes), the determination unit 16e estimates a direction of the specific personal item in the captured image CPx (Step S503).

Here, when the detected specific personal item is a smartphone, the determination unit 16e estimates in which direction the rear surface having the out-camera is directed. In other words, the determination unit 16e estimates a direction of the rear surface of the smartphone, thereby substantially estimating a shooting direction of the out-camera mounted on the smartphone.

As another example, when the detected specific personal item is a writing tool (for example, a pen), the determination unit 16e estimates to which direction the pen is pointing.

Then, the determination unit 16e determines whether or not the person possessing the specific personal item is performing the predetermined prohibited act on the basis of the direction estimated in Step S503 (Step S504). For example, the determination unit 16e determines whether or not the owner is performing an act of recording the display information using the specific personal item (recording unit), which is the act of illegally acquiring the display information displayed on the display screen of the terminal device 10.

For example, when the specific personal item is a smartphone and the rear surface of the smartphone (the shooting direction of the out-camera mounted on the smartphone) is estimated to be directed to the display screen direction of the terminal device 10, the determination unit 16e can determine that the owner of the smartphone is performing the prohibited act. Furthermore, for example, when the specific personal item is a pen and the pen is estimated to be pointing the ground direction, the determination unit 16e can determine that the owner of the pen is performing the prohibited act.

When it is determined that the person possessing the specific personal item is performing the predetermined prohibited act (Step S504; Yes), the output control unit 16f recognizes a risk of shoulder surfing by this person. Then, the output control unit 16f executes the predetermined output control corresponding to the prohibited act (Step S505). For example, the output control unit 16f can generate audio output of the alert information (for example, the alert information indicating “Are you trying to shoot (or transcribe) the screen?”) to warn against unauthorized acquisition of the display information.

According to the example in FIG. 5, the output control unit 16f can generate the audio output of the alert information as described above in order to restrain a person P21, who is an example of the person possessing the specific personal item, from recording the information on the login screen with the recording unit such as the smartphone or the pen.

On the other hand, when it is determined that the person possessing the specific personal item is not performing the predetermined prohibited act (Step S504; No), the output control unit 16f recognizes that there is no risk of shoulder surfing. When there is no risk of shoulder surfing as described above, the output control unit 16f may end the process without performing the output control.

In addition, returning to Step S502, when the personal item is not detected (Step S502; No), the output control unit 16f ends the process without performing the output control.

4-3. Processing Procedure (3)

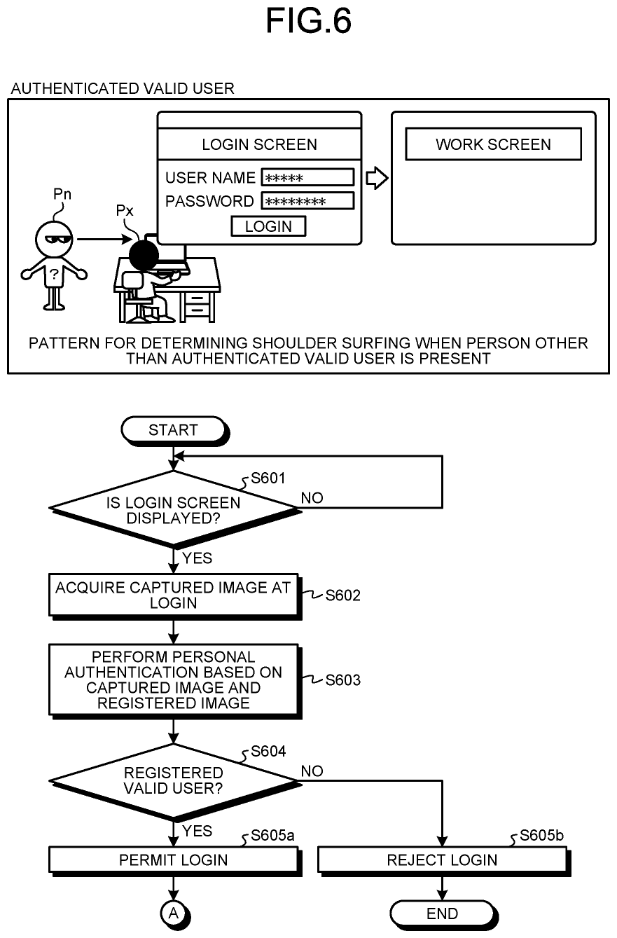

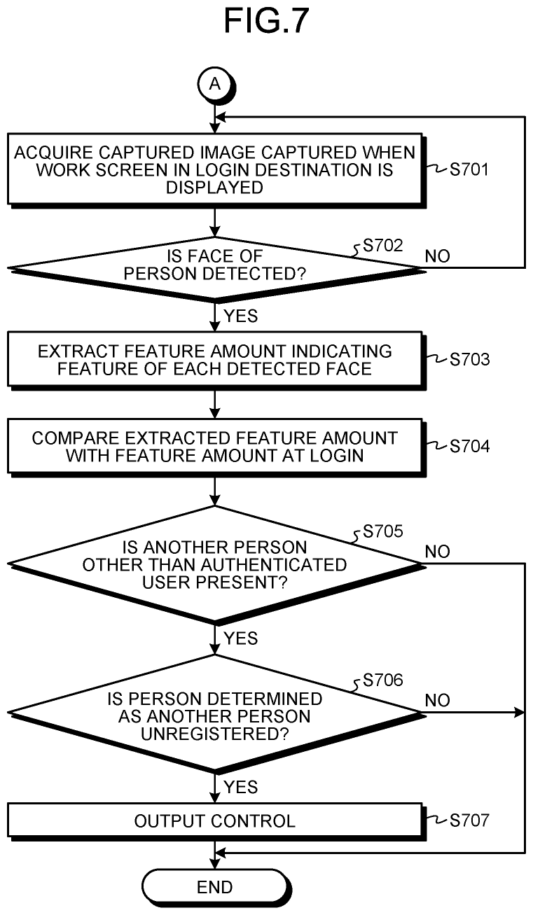

Next, an example of the output control procedure according to the embodiment will be described with reference to FIGS. 6 and 7. FIG. 6 is a flowchart (3-1) illustrating an example of the output control procedure according to the embodiment. FIG. 7 is a flowchart (3-2) illustrating an example of the output control procedure according to the embodiment. The output control procedure illustrated in FIG. 7 continues from FIG. 6.

In addition, FIGS. 6 and 7 illustrate, as one pattern of the output control procedure, an example of a pattern in which a shoulder surfing is determined when a person other than a valid authenticated user is present.

According to the example in FIG. 6, the imaging unit 13 of the terminal device 10 captures the captured image including the face of the detected person each time the presence of the person in the imaging area AR1 is detected.

In such a state, the acquisition unit 16a determines whether or not the login screen is displayed on the display screen of the terminal device 10 (Step S601). While it is determined that the login screen is not displayed (Step S601; No), the acquisition unit 16a waits until the login screen is determined to be displayed.

On the other hand, when it can be determined that the login screen is displayed (Step S601; Yes), the acquisition unit 16a acquires a captured image CPx1 captured at this time by the imaging unit 13 (Step S602).

When the captured image CPx1 is acquired, the authentication unit 16d executes personal authentication of the user Px of the terminal device 10 based on the captured image CPx1 acquired and a registered image RIx registered in advance as the face image (Step S603). In other words, the authentication unit 16d executes face authentication (login authentication) at the time of login. For example, the authentication unit 16d performs personal authentication using a face authentication technology on the basis of the captured image CPx1 and the registered image RIx. A specific example of the personal authentication is as described in FIG. 1, and thus the description thereof is omitted here.

In addition, the authentication unit 16d determines whether or not the user Px is a valid user whose face image is registered, based on the result of the personal authentication in Step S603 (Step S604). For example, when there is a registered image whose similarity exceeds a predetermined threshold in the registered images RIx, the authentication unit 16d authenticates the user Px as a person in the registered image. As a result, the authentication unit 16d can determine that the user Px is the valid user whose face image is registered.

Then, when it is determined that the user Px is the valid user whose face image is registered (Step S604; Yes), the authentication unit 16d permits login to shift the screen to the work screen in the login destination (Step S605a).

On the other hand, when it is determined that the user Px is an unregistered person whose face image is not registered (Step S604; No), the authentication unit 16d rejects the login and the process ends (Step S605b).

Hereinafter, the output control procedure performed after Step S605a will be described with reference to FIG. 7.

The acquisition unit 16a acquires a captured image CPx2 captured when the work screen in the login destination is displayed (Step S701).

When the captured image CPx2 is acquired, the detection unit 16b detects a face of a person in the captured image CPx2 acquired (Step S702). For example, the detection unit 16b detects a face area including the face of the person by image analysis on the captured image CPx2.

Next, when the face of the person is detected (Step S702; Yes), the extraction unit 16c extracts the feature amount indicating a feature of the face for each detected face (Step S703).

Next, the determination unit 16e compares the feature amount extracted in Step S703 with the feature amount extracted from the captured image CPx1 (the feature amount at the time of login extracted from the captured image CPx1 in Step S603) (Step S704).

Then, based on the comparison result, the determination unit 16e determines whether or not a person different from the authenticated valid user Px is present in persons whose faces have been detected in Step S702 (Step S705). In other words, the determination unit 16e determines whether or not another person different from the authenticated user Px is present in the captured image CPx2. For example, when the comparison result indicates that there is a gap between both feature amounts, the determination unit 16e can determine that another person different from the valid user Px is present (presence of another person). On the other hand, when the comparison result indicates matching (or similarity) of the both feature amounts, the determination unit 16e can determine that another person different from the valid user Px does not exist (no presence of another person).

In addition, when it is determined that another person different from the valid user Px is present (Step S705; Yes), the determination unit 16e determines whether or not the person determined to be another person is an unregistered person whose face image is not registered (Step S706). For example, the determination unit 16e can determine whether or not the person determined to be another person is the unregistered person by comparing the feature amount corresponding to the person determined to be the other person among the feature amounts extracted in Step S703 with the feature amount extracted from each of the registered images RIx registered in advance as the face image.

Then, when is it determined that this other person is the unregistered person (Step S706; Yes), the output control unit 16f recognizes a risk of shoulder surfing by the unregistered person. Then, the output control unit 16f executes the predetermined output control corresponding to the presence of the unregistered person (Step S707).

For example, the output control unit 16f can control the display mode of the work screen by a predetermined display control process on the display screen. As an example, the output control unit 16f can reduce the visibility of the work screen by adjusting the brightness of the display screen, or can reduce the visibility of the work screen by performing the mosaic control on the display screen.

According to the example in FIG. 6, the output control unit 16f reduces the visibility so that the work screen cannot be viewed by the other person Pn determined as the unregistered person.

In addition, the output control unit 16f may switch off the power of the display screen itself or reduce the size of the work screen.

In addition, for example, the output control unit 16f may display on the display screen the alert information (for example, text information to warn such as “It will be visible from the person behind”) to warn that there is a risk of peeping at the work screen from the surroundings. Alternatively, the output control unit 16f may generate the audio output of the alert information (for example, alert information to the other person Pn such as “A person behind! Are you trying to view the screen?”) to warn against unauthorized acquisition of information on the work screen.

On the other hand, when the other person is determined to be the registered person (Step S706; No), the output control unit 16f may end the process without performing the output control.

Still more, returning to Step S705, when it is determined that the other person different from the valid user Px does not exist (there is only one user Px) (Step S705; No), the output control unit 16f ends the process without performing the output control.

Note that, when it is determined that the person determined as another person is the unregistered person (Step S706; Yes), the determination unit 16e estimates the direction of the face (or the line-of-sight direction) of the person who has been determined to be another person, for example, on the basis of the captured image CPx2. The determination unit 16e may determine whether or not the work screen is within the field of view of this person on the basis of the estimated direction of the face. Furthermore, when the work screen is within the field of view, the output control unit 16f may execute the predetermined output control corresponding to the presence of the unregistered person.

Furthermore, as another example, when it is determined that the other person is the unregistered person (Step S706; Yes), the determination unit 16e estimates the distance to the terminal device 10 of the person determined as another person, for example, on the basis of the captured image CPx2. The determination unit 16e may determine whether or not the work screen is within the field of view of this person on the basis of the estimated distance.

5. Hardware Configuration

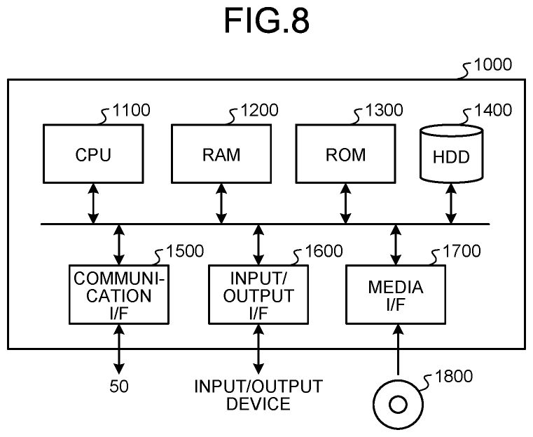

Furthermore, the terminal device 10 described above is realized by, for example, a computer 1000 having a configuration as illustrated in FIG. 8. FIG. 8 is a hardware configuration diagram illustrating an example of a computer that implements the functions of the terminal device 10. The computer 1000 includes a CPU 1100, a RAM 1200, a ROM 1300, an HDD 1400, a communication interface (I/F) 1500, an input/output interface (I/F) 1600, and a media interface (I/F) 1700.

The CPU 1100 operates on the basis of a program stored in the ROM 1300 or the HDD 1400, and controls each unit. The ROM 1300 stores a boot program executed by the CPU 1100 when the computer 1000 is activated, a program depending on hardware of the computer 1000, and the like.

The HDD 1400 stores a program executed by the CPU 1100, data used by the program, and the like. The communication interface 1500 receives data from another device via a predetermined communication network, sends the data to the CPU 1100, and transmits data generated by the CPU 1100 to another device via a predetermined communication network.

The CPU 1100 controls an output device such as a display or a printer and an input device such as a keyboard or a mouse via the input/output interface 1600. The CPU 1100 acquires data from the input device via the input/output interface 1600. In addition, the CPU 1100 outputs generated data to the output device via the input/output interface 1600.

The media interface 1700 reads a program or data stored in the recording medium 1800 and provides the program or data to the CPU 1100 via the RAM 1200. The CPU 1100 loads the program from the recording medium 1800 onto the RAM 1200 via the media interface 1700, and executes the loaded program. The recording medium 1800 is, for example, an optical recording medium such as a digital versatile disc (DVD) or a phase change rewritable disk (PD), a magneto-optical recording medium such as a magneto-optical disk (MO), a tape medium, a magnetic recording medium, a semiconductor memory, or the like.

For example, in a case where the computer 1000 functions as the terminal device 10, the CPU 1100 of the computer 1000 realizes the function of the control unit 16 by executing a program (output control program according to the embodiment) loaded on the RAM 1200. The CPU 1100 of the computer 1000 reads and executes these programs from the recording medium 1800. As another example, these programs may be acquired from another device via a predetermined communication network.

6. Others

Among the processes described in the above embodiments, all or a part of the processes described as being performed automatically can be performed manually, or all or a part of the processes described as being performed manually can be performed automatically by a known method. In addition, the processing procedure, specific name, and information including various types of data and parameters illustrated in the document and the drawings can be arbitrarily changed unless otherwise specified. For example, the various types of information illustrated in each figure are not limited to the illustrated information.

In addition, each component of each device illustrated in the drawings is functionally conceptual, and is not necessarily physically configured as illustrated in the drawings. In other words, a specific form of distribution and integration of devices is not limited to the illustrated form, and all or a part thereof can be functionally or physically distributed and integrated in an arbitrary unit according to various loads, usage conditions, and the like.

In addition, the above-described embodiments can be appropriately combined within a range in which the processes do not contradict each other.

Although some of the embodiments of the present application have been described in detail with reference to the drawings, these are merely examples, and the present invention can be implemented in other forms subjected to various modifications and improvements based on the knowledge of those skilled in the art, including the aspects described in the disclosure of the invention.

In addition, the “section, module, unit” described above can be read as “means”, “circuit”, or the like. For example, the detection unit can be replaced with a detection means or a detection circuit.

According to one aspect of an embodiment, for example, it is possible to provide a user interface for preventing the act of illegally acquiring information of another person.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A non-transitory computer readable storage medium having stored therein an output control program executed by a terminal device, the output control program causing the terminal device to execute:
detecting a specific object from a captured image captured by an imaging unit of the terminal device;
determining whether the specific object detected satisfies a predetermined condition when the specific object is detected in the detecting; and
controlling an output by executing a predetermined output control corresponding to the specific object when the specific object detected is determined as satisfying the predetermined condition in the determining.

2. The output control program according to claim 1, wherein
the detecting includes detecting a person as the specific object,
the determining includes determining whether a plurality of persons is present in front of a screen of the terminal device according to a number of persons detected when the person is detected in the detecting, and
the controlling the output includes executing a predetermined output control corresponding to a presence of the plurality of persons when the plurality of persons is determined to be present in front of the screen of the terminal device in the determining.

3. The output control program according to claim 2, wherein
the determining includes determining whether display information displayed on the screen of the terminal device is within a field of view of at least one of the plurality of persons according to a face direction of each of the plurality of persons estimated from the captured image, a line-of-sight direction of each of the plurality of persons estimated from the captured image, or a distance to the terminal device of each of the plurality of persons estimated from the captured image, and
the controlling the output includes executing the predetermined output control corresponding to the presence of the plurality of persons when the display information is determined to be within the field of view of the at least one of the plurality of persons.

4. The output control program according to claim 1, wherein
the detecting includes detecting a specific personal item possessed by a person as the specific object,
the determining includes determining whether the person possessing the personal item is performing a predetermined prohibited act according to the specific personal item detected when the specific personal item is detected in the detecting, and
the controlling the output includes executing a predetermined output control corresponding to the prohibited act when the person possessing the specific personal item is determined as performing the predetermined prohibited act in the determining.

5. The output control program according to claim 4, wherein
the specific personal item is a predetermined recording unit capable of recording display information displayed on a screen of the terminal device, and
the determining includes determining whether the person is performing an act of recording the display information using the recording unit as the predetermined prohibited act according to a direction of the recording unit detected that is estimated from the captured image when the predetermined recording unit is detected in the detecting.

6. The output control program according to claim 1, further causing the terminal device to execute:
authenticating by personal authentication of a user according to a face image of the user of the terminal device captured by the imaging unit, the personal authentication being performed based on the face image captured at a time of login and the face image registered in advance, wherein
the detecting includes detecting a person as the specific object from a captured image captured while a screen in a login destination is displayed among the captured images when the user is authenticated as a valid person whose face image is registered,
the determining includes determining whether another person different from the user is present in the person detected when the person is detected in the detecting, and
the controlling the output includes executing a predetermined output control corresponding to a presence of the other person when the other person different from the user is determined to be present in the determining.

7. The output control program according to claim 6, wherein
the determining includes determining whether display information displayed on a screen of the terminal device is within a field of view of the other person according to a face direction of the other person estimated from the captured image, a line-of-sight direction of the other person estimated from the captured image, or a distance to the terminal device of the other person estimated from the captured image, and
the controlling the output includes executing the predetermined output control corresponding to the presence of the other person when the display information is determined to be within the field of view of the other person.

8. The output control program according to claim 6, wherein
the controlling the output does not execute the output control when the other person is registered in advance as a related person of the user.

9. The output control program according to claim 6, wherein
the authenticating includes rejecting login by the user when the user cannot be authenticated as the valid person whose face image is registered.

10. The output control program according to claim 1, wherein
the controlling the output includes a display control of a screen of the terminal device as the output control, and the display control corresponding to the specific object controls a display mode of display information displayed on the screen.

11. The output control program according to claim 10, wherein
the controlling the output includes controlling the display mode according to a secrecy level of the display information.

12. The output control program according to claim 10, wherein
the controlling the output includes reducing a visibility of the display information by adjusting brightness of the screen or reducing the visibility of the display information by performing mosaic control on the screen.

13. The output control program according to claim 1, wherein
the controlling the output includes outputting, as the output control, predetermined alert information corresponding to the specific object.

14. The output control program according to claim 13, wherein
the controlling the output includes outputting, as the predetermined alert information, alert information to warn that there is a risk of peeping from surroundings with respect to display information displayed on a screen of the terminal device.

15. The output control program according to claim 13, wherein
the controlling the output includes outputting, as the predetermined alert information, alert information to warn not to perform a prohibited act related to unauthorized acquisition of display information displayed on a screen of the terminal device.

16. An output control method executed by a terminal device, the output control method comprising:
detecting a specific object from a captured image captured by an imaging unit of the terminal device;
determining whether the specific object detected satisfies a predetermined condition when the specific object is detected in the detecting; and
controlling an output by executing a predetermined output control corresponding to the specific object when the specific object detected is determined as satisfying the predetermined condition in the determining.

17. A terminal device comprising:
a detection unit that detects a specific object from a captured image captured by an imaging unit of the terminal device;
a determination unit that determines whether the specific object detected satisfies a predetermined condition when the detection unit detects the specific object; and
an output control unit that executes a predetermined output control corresponding to the specific object when the determination unit determines that the specific object detected satisfies the predetermined condition.
